(19) United States
(12) Patent Application Publication
(10) Pub. No.: US 2016/0148220 A1
(43) Pub. Date: May 26, 2016

(54) METHOD AND SYSTEM FOR IMPACT MODELING OF BRAND REPULSION

(71) Applicant: MasterCard International Incorporated, Purchase, NY (US)

(72) Inventors: Shen Xi MENG, Millwood, NY (US); Po HU, Norwalk, CT (US); Qian WANG, Ridgefield, CT (US)

(73) Assignee: MASTERCARD INTERNATIONAL INCORPORATED, Purchase, NY (US)

(21) Appl. No.: 14/553,630

(22) Filed: Nov. 25, 2014

(51) Int. Cl. G06Q 30/02; G06Q 40/00

(52) U.S. Cl. CPC G06Q 30/0201; G06Q 40/12

(57) ABSTRACT

A method for identifying repulsive brands includes: storing a plurality of brand profiles, each brand profile including data related to a brand including a brand identifier and a plurality of competitor brand identifiers associated with competitors to the related brand; storing a plurality of transaction data entries, each transaction data entry including data related to a payment transaction involving a consumer including a specific brand identifier associated with a brand involved in the related payment transaction; identifying an associated brand profile for each transaction data entry where the included brand identifier corresponds to the specific brand identifier included in the respective transaction; and identifying repulsive brands based on inclusion of an associated competitor brand identifier in the competitor brand identifiers included in each associated brand profile identified for each transaction data entry in the transaction database.

### FIELD

The present disclosure relates to the modeling of brand repulsion, specifically the identification of repulsive brands for a consumer based on transaction history and additional data.

### BACKGROUND

Merchants, retailers, manufacturers, advertisers, content providers, and other entities often try to identify as much information as possible about consumers. By learning about a consumer's shopping preferences, travel preferences, brand preferences, product interests, habits, etc., an entity can often achieve better consumer targeting with advertisements, coupons, deals, and other content. For example, a department store may gain increased business with a consumer the store knows to be interested in electronics by advertising electronic deals to the consumer.

Traditionally, these entities have often been interested in such “positive” information, the positive interests and preferences of a consumer. However, for many consumers, “negative” interests and preferences, such as brand repulsion, may be just as important for a consumer's shopping habits. For example, a consumer may have a negative preference for a specific brand of clothing. The consumer may thereby have no preference for the type of clothing they will purchase, as long as it is not the brand they find repulsive. Such an effect can greatly change the way the consumer may be targeted, as considerations other than brand, such as price, availability, etc., may therefore be more influential.

However, due to the long history of gathering and analysis of positive information, many existing systems are unable to receive and identify negative brand information, as well as unable to perform analysis on such information to identify brand repulsions for consumers. As a result, existing systems may have little to offer merchants, advertisers, content providers, and other entities for the targeting of consumers that do not have specific brand preferences. Thus, there is a need for a technical solution to identify repulsive brands for consumers based on transaction data and other sources, such as surveys, social network data, etc., which may be used to improve consumer targeting.

### SUMMARY

The present disclosure provides a description of systems and methods for identifying repulsive brands.

A method for identifying repulsive brands includes: storing, in a brand database, a plurality of brand profiles, wherein each brand profile includes data related to a brand including at least a brand identifier and a plurality of competitor brand identifiers associated with competitors to the related brand; storing, in a transaction database, a plurality of transaction data entries, wherein each transaction data entry includes data related to a payment transaction involving a consumer including at least a specific brand identifier associated with a brand involved in the related payment transaction; identifying, by a processing device, an associated brand profile for each transaction data entry in the transaction database where the included brand identifier corresponds to the specific brand identifier included in the respective transaction data entry; and identifying, by the processing device, one or more repulsive brands based on inclusion of an associated competitor brand identifier in the plurality of competitor brand identifiers included in each associated brand profile identified for each transaction data entry in the transaction database.

A system for identifying repulsive brands includes a brand database, a transaction database, and a processing device. The brand database is configured to store a plurality of brand profiles, wherein each brand profile includes data related to a brand including at least a brand identifier and a plurality of competitor brand identifiers associated with competitors to the related brand. The transaction database is configured to store a plurality of transaction data entries, wherein each transaction data entry includes data related to a payment transaction involving a consumer including at least a specific brand identifier associated with a brand involved in the related payment transaction. The processing device is configured to: identify an associated brand profile for each transaction data entry in the transaction database where the included brand identifier corresponds to the specific brand identifier included in the respective transaction data entry; and identify one or more repulsive brands based on inclusion of an associated competitor brand identifier in the plurality of competitor brand identifiers included in each associated brand profile identified for each transaction data entry in the transaction database.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying repulsive brands using transaction history in accordance with exemplary embodiments.

FIG. 2 is a block diagram illustrating the processing server of FIG. 1 for the identification of repulsive brands in accordance with exemplary embodiments.

FIG. 3 is a diagram illustrating the identification of repulsive brands based on transaction history and brand relationships in accordance with exemplary embodiments.

FIG. 4 is a diagram illustrating the impact of consumer purchases on brand repulsion in accordance with exemplary embodiments.

FIG. 5 is a flow diagram illustrating a process for improving consumer modeling based on brand repulsion in accordance with exemplary embodiments.

FIG. 6 is a flow chart illustrating an exemplary method for identifying repulsive brands in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual or token based, such as those accounts operated by PayPal®, etc.

Brand—Name, term, design, symbol, or any other feature that identifies one product, good, service, merchant, manufacturer, etc. from another. Brand may refer to the product itself, the style of a product, the manufacturer, a retailer of the product, etc. For example, brands may include merchants, manufacturers, product lines, concept, or any other intangible for which a consumer may prefer one over another. In a single payment transaction, multiple brands may be involved. For instance, the purchase of an item of clothing may involve a clothing style brand, product line brand, the clothing manufacturer brand, merchant brand, and management brand.

### System for Identifying Repulsive Brands

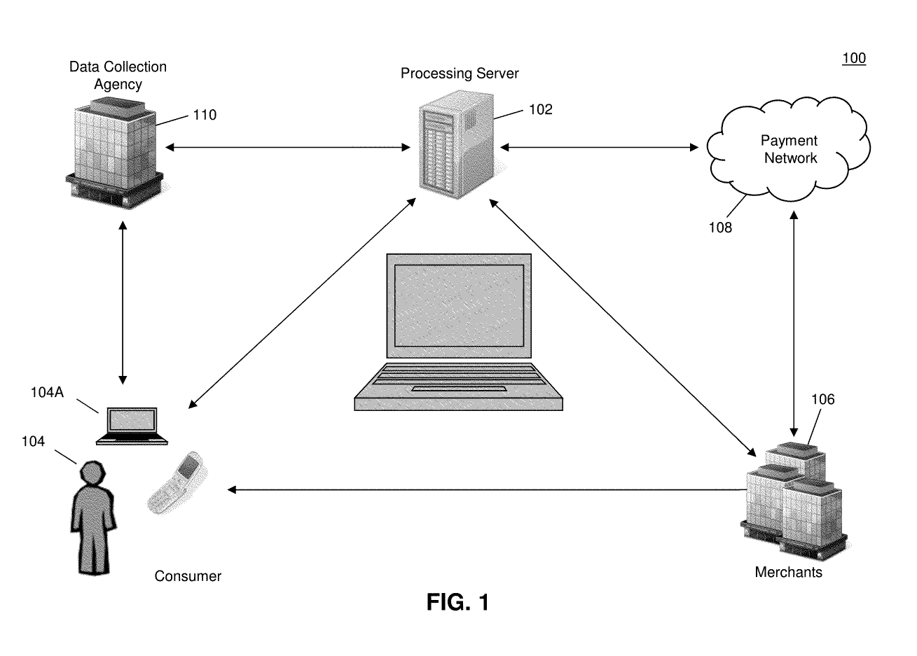

FIG. 1 illustrates a system 100 for the identification of repulsive brands based on brand associations and transaction history.

The system 100 may include a processing server 102. The processing server 102, discussed in more detail below, may be configured to identify brand repulsions for one or more consumers 104. Brand repulsions may be identified using at least transaction history for a plurality of payment transactions involving the consumer 104 and one or more brand associations. In some instances, additional data may be used, such as consumer preferences, social network data, product return data, customer service data, etc. that may be provided by the consumer 104 and/or obtained with consent of the associated consumer 104 via various databases, servers and computer systems. The processing server 102 may use the data and identify one or more repulsive brands for the consumer 104 using the methods and systems discussed herein.

A consumer 104 may conduct payment transactions with one or more merchants 106 via point of interaction terminals, including point of sale terminals or personal computing devices 104A. The payment transactions may be processed by a payment network 108. Transaction data for each of the payment transactions may be transmitted to the processing server 102. In some embodiments, the processing server 102 may be a part of the payment network 108 and may be configured to receive the transaction data as part of the processing of payment transactions by the payment network 108. In a further embodiment, the processing server 102 may be configured to process payment transactions using methods and systems that will be apparent to persons having skill in the relevant art.

The processing server 102 may receive the transaction data for a plurality of payment transactions involving one or more consumers 104 and one or more merchants 106. Each payment transaction may include at least one brand identifier associated with a brand involved in the payment transaction. In some embodiments, the transaction data for a payment transaction may include a plurality of brands, such as a style brand, product line brand, manufacturer brand, merchant brand, and management brand. The processing server 102 may identify one or more repulsive brands for each of the brands involved in the payment transaction.

Repulsive brands may be identified via brand associations between a brand involved in the payment transaction and the repulsive brand(s). The identification of a brand as repulsive to another brand may be based on data received from a data collection agency 110 configured to identify brand associations. For example, the data collection agency 110 may indicate that Brand A and Brand B are competitors, and therefore a purchase of a product having Brand A indicates a repulsion to Brand B. Data that may be used to identify brand associations can include advertising data, survey data, transaction data, merchant data, crowd sourcing data, etc. For instance, the data collection agency 110 may survey consumers 104 and merchants 106 regarding brand associations, may visit merchants 106 to identify brands and competitors based on available products, may survey brands themselves for identification of competitors, etc. Additional methods that may be suitable for identifying brand associations will be apparent to persons having skill in the relevant art.

In some embodiments, the processing server 102 may be configured to identify one or more brand associations, such as based on transaction data. For example, if a first group of consumers 104 regularly purchase products in a specific category by Brand A, and a second group of consumers 104 regularly purchase products in the same category by Brand B, the processing server 102 may determine Brand A and Brand B to be competitors, and may thereby determine that the purchase of products by Brand A indicates a repulsion to Brand B. Brand association data that is identified by the processing server 102 and/or received (e.g., from the data collection agency 110) may be stored in a database for use by the processing server 102 in identifying repulsive brands.

The processing server 102 may identify, for each payment transaction that involves a consumer 104, the brands involved in each of the payment transactions based on the included brand identifiers. The processing server 102 may then identify one or more repulsed brands in each payment transaction based on brand associations with the involved brands. The processing server 102 may then identify one or more repulsive brands for the consumer 104 based on the identified one or more repulsed brands. In some instances, a repulsive brand may be identified based on frequency of the brand as the repulsed brand in the payment transactions. In a further instance, it may be further identified based on the frequency of the brand as a repulsed brand compared to frequency of the brand as a brand involved in the payment transactions.

For example, Brands A, B, and C are competitor merchants 106, and the consumer 104 regularly purchases at Brand A, then Brands B and C may be identified as repulsed brands in each transaction with Brand A. However, if the consumer 104 also regularly purchases at Brand B, then Brand B may not be considered a repulsive brand. In such an instance, Brand C may be the only repulsive brand for the consumer 104 based on the recurring transactions at Brands A and B.

In such an example, the methods and systems discussed herein may be more effective in the targeting of consumers than traditional methods and systems. For instance, the consumer 104 may not have a preference between Brands A and B, and thus no related information may be identified for the consumer 104 for use in targeting by an advertiser or content provider. Conversely, in the systems and methods discussed herein, the consumer 104 may be identified as having an aversion to Brand C, which may provide an advertiser or content provider with information that may be used in the targeting of the consumer 104, such as advertisements for products offered at both Brands A and B, advertisements to the most convenient location of either Brand A or Brand B, etc.

In some embodiments, the processing server 102 may be configured to perform predictive modeling for consumers based on brand repulsions and transaction data. For instance, the processing server 102 may be configured to store brand repulsion data for a consumer 104. The brand repulsion data may be based on repulsive brands identified via transactions involving the consumer 104, as well as additional data, such as consumer-supplied data (e.g., brand preferences, repulsive brands, etc.), product return data (e.g., returning of a product indicating a revulsion to an associated brand), customer service data (e.g., complaints about a product indicating a revulsion to the associated brand), product review data (e.g., negative reviews indicating a revulsion to the associated brand), social network data (e.g., “following” a brand on Twitter® indicating a revulsion to competitors brands, membership in a social network group protesting a brand indicating a revulsion to that brand, etc.), etc.

In some instances, brand repulsions may also be identified based on associations of brands with one or more consumer characteristics. For instance, if a consumer 104 is identified (e.g., via surveys, social network data, or other data obtained via consumer consent) as a strong supporter of a certain social value, brands that are actively against that social value may be identified as being repulsed by the consumer 104, and vice versa. For example, a consumer 104 strongly interested in the rescue of animals may be identified as being repulsed by a cosmetic manufacturer that tests on animals.

Once repulsive brands are identified for a consumer 104, the processing server 102 may use one or more rules or algorithms to predict the consumer's 104 behavior based thereon using predictive modeling. Predictive modeling may be used to identify brands the consumer 104 may purchase based on their repulsions, identify additional criteria a consumer 104 may use for a purchase (e.g., best priced brand, best reviewed brand, etc. among non-repulsive brands, fastest shipping time, closest merchant location, etc.), and other criteria that may be suitable for use by the processing server 102 or other entity, such as merchants, advertisers, content providers, etc. in content targeting. For example, the processing server 102 may identify that a consumer 104 is repulsive to Brand C, and has no preference among Brands A and B, and is most likely to purchase any product by either brand based on a combination of price and convenience. The processing server 102 may provide this data to a suitable entity for use in targeting the consumer 104.

The methods and systems discussed herein may enable the processing server 102 to identify brands that are repulsive to a consumer 104 based on transaction data and brand associations, which may be unavailable to existing systems, and for which existing systems may be unable to analyze to determine brand repulsions. In addition, the processing server 102 may be able to use the identified brand repulsions and other data in predictive modeling, which may be beneficial in the targeting of consumers 104 in instances where traditional consumer targeting using positive information may be inadequate or unavailable. As a result, the methods and systems discussed herein may provide significant technical improvements in the targeting of consumers 104 and identification of data associated therein.

### Processing Server

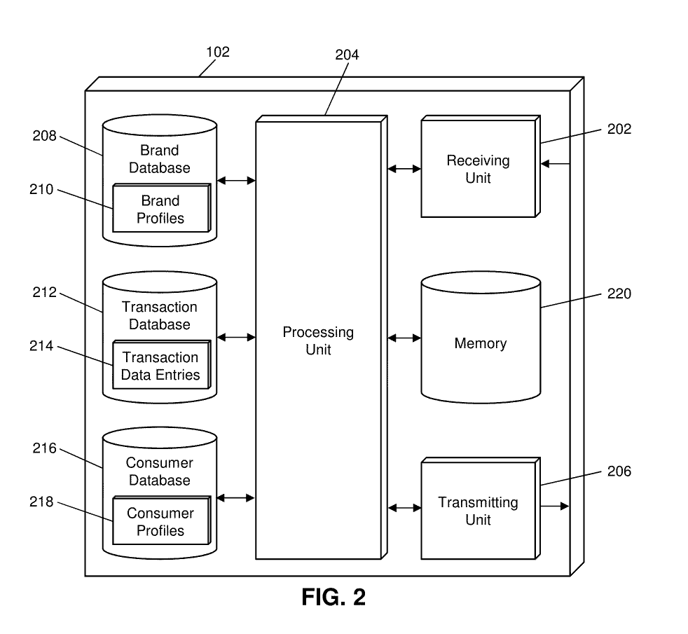

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 7 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data for a plurality of payment transactions from the payment network 108. In embodiments where the processing server 102 may be a part of the payment network 108, the receiving unit 202 may receive the transaction data from merchants 106, acquiring financial institutions, or additional computing devices included in the payment network 108. The receiving unit 202 may also be configured to receive brand association data, such as from the data collection agency 110. In some embodiments, the receiving unit 202 may also be configured to receive data requests, such as from merchants 106, advertisers, content providers, etc., which may include requests for brand repulsion data or predictive modeling data.

The processing server 102 may include a brand database 208. The brand database 208 may be configured to store a plurality of brand profiles 210. Each brand profile 210 may include data related to a brand including at least a brand identifier and a plurality of competitor brand identifiers. The brand identifier may be a unique value associated with the related brand suitable for identification of the related brand and/or the respective brand profile 210. The brand identifier may be, for instance, an identification number, name, product identifier, universal product code, or other suitable value that will be apparent to persons having skill in the relevant art. The plurality of competitor brand identifiers may include brand identifiers associated with brands that are competitors of the related brand. “Competitors” may refer to brands that actively compete with the related brand, or any brand where a consumer 104 may make a selection between one brand and another.

The processing server 102 may also include a transaction database 212. The transaction database 212 may be configured to store a plurality of transaction data entries 214. Each transaction data entry 214 may include data related to a payment transaction and including at least a consumer identifier and one or more specific brand identifiers. The consumer identifier may be a unique value suitable for use in identifying a consumer involved in the related payment transaction, such as a transaction account number, identification number, username, phone number, e-mail address, etc. The one or more specific brand identifiers may be brand identifiers associated with brands involved in the related payment transaction. Brand identifiers may be included in product data, merchant data, offer data, or any other data included in a transaction data entry 214. For example, brand identifiers for style or manufacturer brands may be included in product data or offer data, a brand identifier for a merchant brand may be included in the merchant data, etc.

The processing server 102 may further include a processing unit 204. The processing unit 204 may be configured to perform the functions of the processing server 102 suitable for performing the methods and systems disclosed herein as will be apparent to persons having skill in the relevant art. The processing unit 204 may be configured to identify transaction data entries 214 in the transaction database 212 that are associated with a specific consumer 104 or group of consumers 104 based on the consumer identifiers included in the transaction data. The processing unit 204 may then identify brand identifiers included in each transaction data entry 214, and may identify, for each of the transaction data entries 214, brand profiles 210 that include the identified brand identifiers.

Once the brand profiles 210 have been identified for each transaction, the processing unit 204 may identify one or more repulsive brands for the associated consumer 104 or consumers 104 based on the one or more competitor brands included in each of the identified brand profiles 210. In some embodiments, the processing unit 204 may identify repulsive brands based on the frequency of the repulsive brand in the plurality of competitor brands in the identified brand profiles 210. In a further embodiment, the frequency may be compared to a frequency of the brand identifier as included in the identified transaction data entries 214.

In some embodiments, the processing server 102 may also include a consumer database 216. The consumer database 216 may be configured to store a plurality of consumer profiles 218. Each consumer profile 218 may include data related to a consumer 104 including at least a consumer identifier associated with the related consumer 104. In some embodiments, each consumer profile 218 may include transaction data entries 214 for payment transactions involving the related consumer 104 and including the associated consumer identifier. In a further embodiment, the processing server 102 may include the consumer database 216 in place of the transaction database 212. The processing unit 204 may be configured to store identified repulsive brands in the consumer profile 218 associated with the consumer 104 for whom the repulsive brands were identified.

In some embodiments, each consumer profile 218 may include additional consumer data, such as consumer brand preferences, survey data, social network data, call center data, product return data, customer service data, etc. In such an embodiment, the processing unit 204 may be configured to use the additional consumer data included in the consumer profile 218 in the identification of one or more repulsive brands. For example, if the consumer 104 regularly purchases a competitor item for a specific brand, the specific brand may not be considered repulsive to the consumer 104 if the consumer 104 rates the brand highly despite the common purchase of competitor items, such as due to cost, convenience, etc.

In some instances, the processing unit 204 may be configured to update consumer brand repulsions upon the receipt of new transaction data. In such an instance, the receiving unit 202 may receive transaction data for a new payment transaction, where the transaction data includes a consumer identifier associated with a consumer 104 involved in the new payment transaction and a brand identifier. The processing unit 204 may identify a brand profile 210 associated with the brand identifier and may identify the competitor brands included therein. The processing unit 204 may update brand repulsions stored in the consumer profile 218 that includes the consumer identifier based on the identified competitor brands. In some instances, updating of the brand repulsions may result in the identification of a new brand as a repulsive brand, and/or the identification of a previously repulsive brand as a non-repulsive brand (e.g., if the previously repulsive brand was involved in the new payment transaction).

In some embodiments, the processing unit 204 may be further configured to apply predictive modeling to a consumer 104. In such an embodiment, rules or algorithms for predictive modeling may be stored in a memory 220 in the processing server 102. The processing unit 204 may apply the rules or algorithms to the data stored in the consumer profile 218 for a consumer 104, such as the brand repulsion data, consumer preference data, transaction data, etc. The processing unit 204 may apply the rules and may identify one or more predictive models, predictions, etc., which may be used in the targeting of the related consumer 104.

In some instances, the processing server 102 may include a transmitting unit 206. The transmitting unit 206 may be configured to transmit data over one or more networks via one or more network protocols. The transmitting unit 206 may be configured to transmit brand repulsion data, predictive modeling data, etc. In some instances, the data may be transmitted in response to a request received by the receiving unit 202. In some embodiments, the transmitting unit 206 may transmit data requests, such as surveys transmitted to consumers 104 for the receipt of brand preferences or to other entities (e.g., social networks, call centers, merchants 106, the data collection agency 110, etc.) for consumer data and/or brand association data. In such an embodiment, the receiving unit 202 may be configured to receive data in response to the transmitted data request.

In one example, the receiving unit 202 may receive a request for a prediction for a consumer 104 for purchase of a new digital camera. The consumer 104 may have no preference among digital camera brands or merchants, and may therefore have no basis of information for use by an advertiser or merchant 106 using traditional systems. The receiving unit 202 may receive the request and the processing unit 204 may identify a consumer profile 218 for the consumer 104. The consumer profile 218 may then identify relevant brands that are repulsive to the consumer 104, such as electronics merchants, digital camera manufacturers, and digital camera product lines. The processing unit 204 may thereby apply predictive modeling to the consumer data to determine a prediction of both where the consumer 104 may be willing or likely to go, and what digital camera the consumer 104 may be willing or likely to purchase. The transmitting unit 206 may then transmit the prediction as a response to the received request.

The memory 220 may be configured to store data suitable for performing the functions of the processing server 102 discussed herein. For example, the memory 220 may store rules or algorithms for predictive modeling, rules or algorithms for identifying repulsive brands based on consumer data, surveys and data requests for consumer or brand data, etc. Additional data that may be stored in the memory 220 will be apparent to persons having skill in the relevant art.

It will be further apparent to persons having skill in the relevant art that, in some embodiments, the processing server 102 may include additional components suitable for performing the functions discussed herein. For example, in embodiments where survey data may be received by the processing server 102 for use in identifying brand associations or consumer preferences, the survey data may be input into the processing server 102 by an input unit, such as a keyboard, mouse, touch screen, camera, microphone, etc. In another example, the processing server 102 may include a display unit, such as a touch screen display, liquid crystal display, etc. for displaying data to a user, such as brand repulsion data for a consumer 104.

It will also be apparent to persons having skill in the relevant art that the components of the processing server 102 illustrated in FIG. 2 and discussed herein may be further configured to perform additional functions of the processing server 102 as necessary. For instance, in embodiments where the processing server 102 may be a part of the payment network 108, the components of the processing server 102 may be further configured to perform the necessary functions of the payment network 108 for processing payment transactions, such as the receipt and forwarding of authorization requests.

### Identification of Repulsive Brands Based on Transaction Data

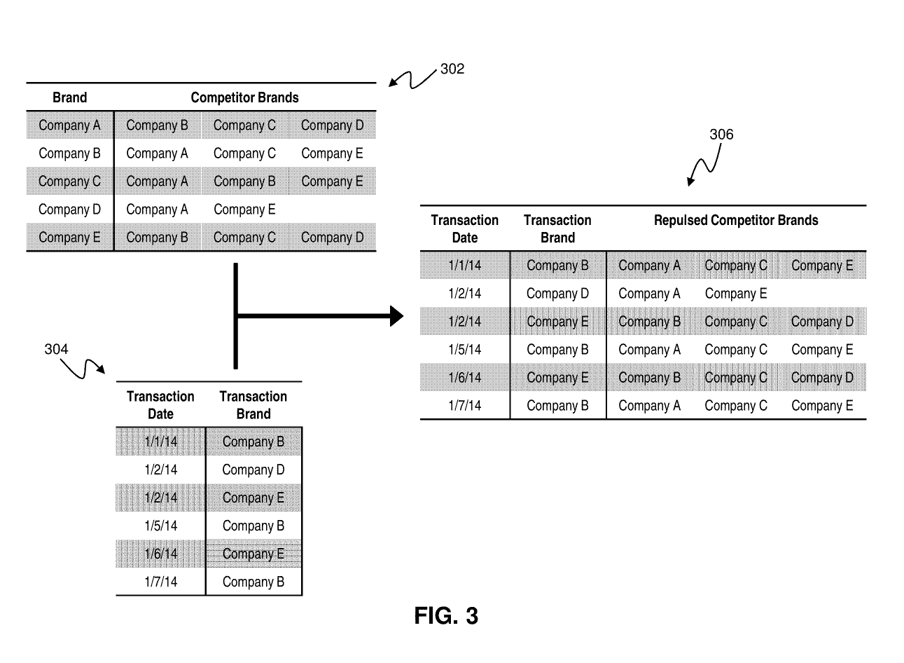

FIG. 3 illustrates the identification of repulsive brands based on transaction data and brand associations.

Table 302 includes a plurality of brand profiles, such as the brand profiles 210 stored in the brand database 208 in the processing server 102. Each brand profile includes a brand, such as Companies A, B, C, D, and E, as well as, for each of the brands, a plurality of competitor brands. For instance, Company A has competitor brands in Companies B, C, and D.

Table 304 includes a plurality of transaction data entries, such as the transaction data entries 214 stored in the transaction database 212 of the processing server 102 for a specific consumer 104. As illustrated in the table 306, the consumer 104 may have conducted six payment transactions during a seven day period. Each transaction data entry includes a brand involved in the respective payment transaction, such as Company B being involved in the payment transaction conducted on Jan. 1, 2014.

As discussed herein, the processing unit 204 of the processing server 102 may be configured to identify, for each transaction data entry in the table 306, one or more repulsed brands based on the brand involved in the related payment transaction. The repulsed brands may be identified using the corresponding brand profiles, as included in table 302. The identification of the brand profiles and included competitor brands may result in table 306, which illustrates each transaction data entry and the corresponding repulsed competitor brands based on the involved brand and the competitor brands included in the involved brand's corresponding brand profile from table 302.

In the example illustrated in FIG. 3, the processing unit 204 may identify Company A and Company C as being repulsive brands. Although each company is listed multiple times in the repulsed competitor brands of table 304, the consumer 104 has conducted payment transactions with each of Companies B, D, and E, indicating that the companies are not repulsive to the consumer 104. Company A is listed as a repulsed brand four times, and Company C five times, with no transactions involving either brand, thus indicating each company to be repulsive to the consumer 104.

### Updating of Brand Repulsion Based on Conducted Transaction

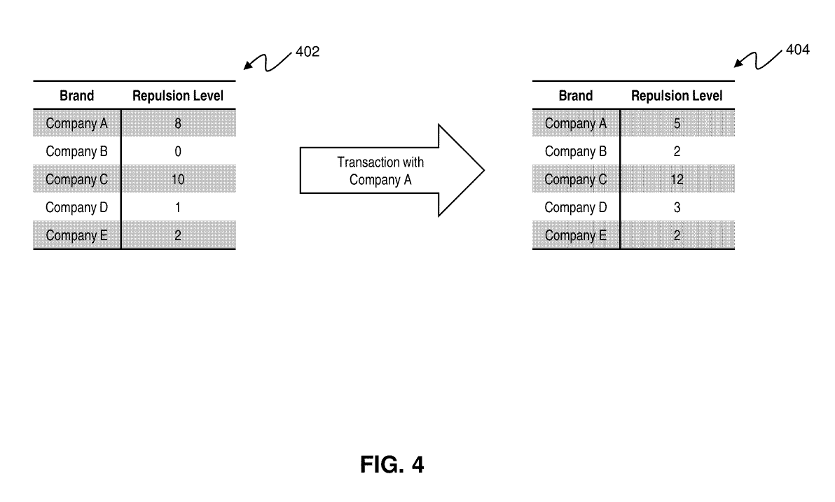

FIG. 4 illustrates the updating of repulsive brands for a consumer 104 based on a newly conducted payment transaction.

Table 402 lists a plurality of brands and corresponding repulsion levels for a consumer 104, such as stored in an associated consumer profile 218. The repulsion level for each brand may be determined by the transaction data as discussed above, and may also be based on consumer data supplied by the consumer 104 and/or obtained via consent of the consumer 104. In the example illustrated in FIG. 4, the repulsion levels are based on the repulsed competitor brands identified in table 306 in FIG. 3. In the illustrated example, each brand gains two levels for each transaction where the brand is a repulsed competitor brand, and each brand loses three levels for each transaction involving the brand. Therefore, Company E has a repulsion level of two, due to being a repulsed competitor brand in four transactions (plus 8 levels) and being involved in two transactions (minus 6 levels).

In the example, the consumer 104 may conduct a payment transaction where Company A is involved, such as being the merchant 106 with whom the transaction is conducted, a manufacturer of a purchased product, etc. Table 404 illustrates changes in the repulsion levels for the consumer 104 based on the transaction. As Company A was involved in the transaction, their level is deducted by three points, resulting in a repulsion level of 5. As illustrated in table 302 of FIG. 3, Companies B, C, and D are competitors to Company A, and therefore the repulsion brands of each of the three companies are increased by two points, to 2, 12, and 3, respectively.

Based on the updated repulsion levels, Company C may still be considered a repulsive brand for the consumer 104, but, in some instances, Company A may no longer be considered a repulsive brand. For example, if the processing unit 204 determines that a repulsive brand may identify only those with a repulsion level above a predetermined amount (e.g., as stored in the memory 220). In instances where the predetermined amount is level six, Company A would no longer be considered repulsive brand after the transaction.

It will be apparent to persons having skill in the relevant art that the example illustrated in FIG. 4 and discussed herein is provided as an illustration only, and that other numbers, calculations, and considerations may be used in determining repulsive brands based on transaction history and brand associations and the effect of a new payment transaction on a repulsive brand using the methods and systems discussed herein.

### Process for Identifying Repulsive Brands

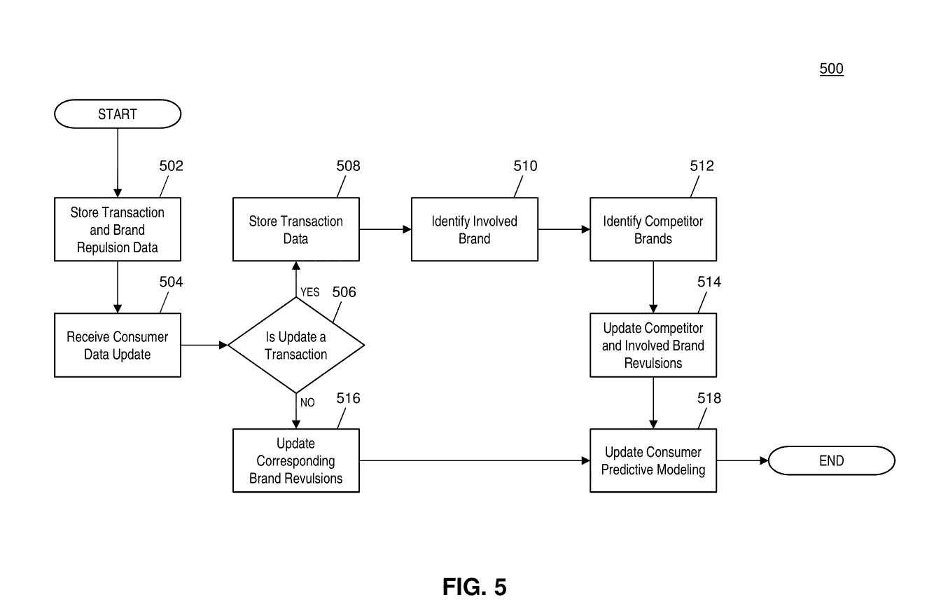

FIG. 5 illustrates a process 500 for identifying repulsive brands based on transaction data and use therein in predicting consumer behavior using the processing server 102.

In step 502, the processing unit 204 may store transaction data and brand repulsion data in the brand database 208, transaction database 212, and consumer database 216 of the processing server 102. The brand database 208 may store brand profiles 210, where each brand profile 210 includes a brand identifier and a plurality of competitor brand identifiers. The transaction database 212 may store transaction data entries 214 for payment transactions involving a consumer 104 that include brand identifiers. The consumer database 216 may store a consumer profile 218 for the consumer that includes brand repulsion data, such as brand repulsion levels, consumer-supplied data, and additional consumer data.

In step 504, the receiving unit 202 may receive a consumer data update. The consumer data update may include any type of data suitable for use by the processing unit 204 in updating consumer brand repulsion data, such as transaction data, survey data, social network data, product return data, customer service data, product review data, etc. In step 506, the processing unit 204 may determine if the consumer data update is in the form of transaction data for a payment transaction involving the consumer 104. If the consumer data update is a payment transaction, then, in step 508, the processing unit 204 may store the transaction data as a new transaction data entry 214 in the transaction database 212.

In step 510, the processing unit 204 may identify a brand profile 210 in the brand database 208 for a brand involved in the payment transaction where the brand identifier included in the brand profile 210 corresponds to the brand identifier included in the received transaction data. In step 512, the processing unit 204 may identify competitor brands for the brand involved in the transaction, as indicated by the plurality of competitor brand identifiers included in the identified brand profile 210. In step 514, the processing unit 204 may update the brand repulsions of the consumer 104 as included in the consumer profile 218 for the competitor brands and the brand involved in the payment transaction. In some embodiments, updating the brand repulsions may include modifying brand repulsion levels for each of the brands. In other embodiments, updating the brand repulsions may include identifying any repulsed brands based on the transaction data including the new transaction.

If, in step 506, it was determined that the consumer data update was not a transaction, then, in step 516, the processing unit 204 may update the brand revulsions for the consumer 104 in the consumer profile 218 based on the data update. For instance, if the data update is a survey of consumer preference levels for merchants 106, the processing unit 204 may update repulsion levels, and thereby identified repulsive brands, accordingly.

Once the consumer profile 218 has been updated as a result of the new transaction data or other type of consumer data update, then, in step 518, the processing unit 518 may update predictive modeling for the consumer 104 based thereon.

### Exemplary Method for Identifying Repulsive Brands

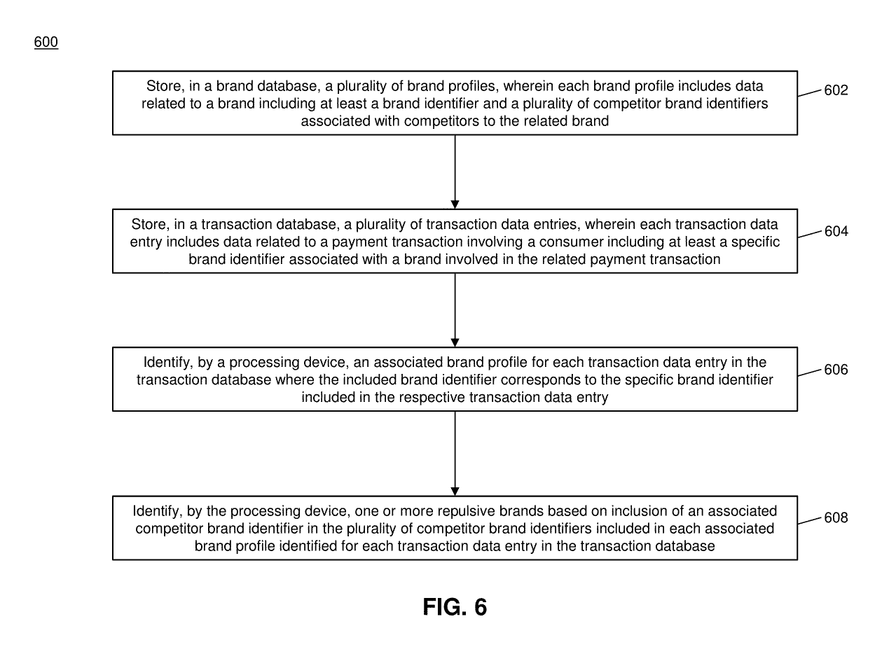

FIG. 6 illustrates a method 600 for identifying repulsive brands based on transaction data and brand relationships.

In step 602, a plurality of brand profiles (e.g., brand profiles 210) may be stored in a brand database (e.g., the brand database 208), wherein each brand profile 210 includes data related to a brand including at least a brand identifier and a plurality of competitor brand identifiers associated with competitors to the related brand.

In step 604, a plurality of transaction data entries (e.g., transaction data entries 214) may be stored in a transaction database (e.g., the transaction database 212), wherein each transaction data entry 214 includes data related to a payment transaction involving a consumer (e.g., the consumer 104) including at least a specific brand identifier associated with a brand involved in the related payment transaction.

In step 606, an associate brand profile 210 may be identified by a processing device (e.g., the processing unit 204) for each transaction data entry 214 in the transaction database 212 where the included brand identifier corresponds to the specific brand identifier included in the respective transaction data entry 214.

In step 608, one or more repulsive brands may be identified by the processing device 204 based on inclusion of an associated competitor brand identifier in the plurality of competitor brand identifiers included in each associated brand profile 210 identified for each transaction data entry 214 in the transaction database 212. In one embodiment, the one or more repulsive brands are identified based on a frequency of the associated competitor brand identifier in the identified associated brand profiles 210.

In some embodiments, the method 600 may further include storing, in a profile database (e.g., the consumer database 216), a consumer profile (e.g., the consumer profile 218), wherein the consumer profile 218 includes data related to the consumer 104. In a further embodiment, the method 600 may even further include storing, in the consumer profile 218, the identified one or more repulsive brands. In an even further embodiment, the consumer profile may further include a plurality of brand preference levels, each brand preference level being associated with a brand, and where the one or more repulsive brands are identified based on a brand preference level of the plurality of brand preference levels associated with the respective repulsive brand.

In a further embodiment, the method 600 may even further include receiving, by a receiving device (e.g., the receiving unit 202), transaction data for a payment transaction involving the consumer 104, wherein the transaction data includes at least an involved brand identifier. In an even further embodiment, the method 600 may still further include updating, in the consumer profile 218, a brand preference level associated with a brand associated with the involved brand identifier. In yet another further embodiment, the method 600 may also include: identifying, by the processing device 204, a specific brand profile 210 where the included brand identifier corresponds to the involved brand identifier; and updating, in the consumer profile 218, a brand preference level associated with a brand associated with each competitor brand identifier included in the identified specific brand profile 210.

In another further embodiment, the involved brand identifier may correspond to a repulsed brand of the one or more repulsive brands, and the method 600 may further include removing, from the consumer profile 218, the repulsed brand corresponding to the involved brand identifier. In some further embodiments, the plurality of brand reference levels may be based on at least one of: transaction history, survey data, product return data, customer service data, social media data, and related consumer data.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 5 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 5 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying repulsive brands. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying repulsive brands, comprising:
storing, in a brand database, a plurality of brand profiles, wherein each brand profile includes data related to a brand including at least a brand identifier and a plurality of competitor brand identifiers associated with competitors to the related brand;
storing, in a transaction database, a plurality of transaction data entries, wherein each transaction data entry includes data related to a payment transaction involving a consumer including at least a specific brand identifier associated with a brand involved in the related payment transaction;
identifying, by a processing device, an associated brand profile for each transaction data entry in the transaction database where the included brand identifier corresponds to the specific brand identifier included in the respective transaction data entry; and
identifying, by the processing device, one or more repulsive brands based on inclusion of an associated competitor brand identifier in the plurality of competitor brand identifiers included in each associated brand profile identified for each transaction data entry in the transaction database.

2. The method of claim 1, wherein the one or more repulsive brands are identified based on a frequency of the associated competitor brand identifier in the identified associated brand profiles.

3. The method of claim 1, further comprising:
storing, in a profile database, a consumer profile, wherein the consumer profile includes data related to the consumer.

4. The method of claim 3, further comprising:
storing, in the consumer profile, the identified one or more repulsive brands.

5. The method of claim 4, wherein
the consumer profile further includes a plurality of brand preference levels, each brand preference level associated with a brand, and
the one or more repulsive brands are identified further based on a brand preference level of the plurality of brand preference levels associated with the respective repulsive brand.

6. The method of claim 5, further comprising:
receiving, by a receiving device, transaction data for a payment transaction involving the consumer, wherein the transaction data includes at least an involved brand identifier.

7. The method of claim 6, further comprising:
updating, in the consumer profile, a brand preference level associated with a brand associated with the involved brand identifier.

8. The method of claim 6, further comprising:
identifying, by the processing device, a specific brand profile where the included brand identifier corresponds to the involved brand identifier; and
updating, in the consumer profile, a brand preference level associated with a brand associated with each competitor brand identifier included in the identified specific brand profile.

9. The method of claim 6, wherein
the involved brand identifier corresponds to a repulsed brand of the one or more repulsive brands, and the method further comprises:
removing, from the consumer profile, the repulsed brand corresponding to the involved brand identifier.

10. The method of claim 5, wherein the plurality of brand preference levels are based on at least one of: transaction history, survey data, product return data, customer service data, social media data, and related consumer data.

11. A method for identifying repulsive brands, comprising:
storing, in a profile database, a consumer profile, wherein the consumer profile includes data related to a consumer including at least a plurality of brand preference levels, each brand preference level being associated with a brand;
storing, in a brand database, a plurality of brand profiles, wherein each brand profile includes data related to a brand including at least a brand identifier and a plurality of competitor brand identifiers associated with competitors to the related brand;
storing, in a transaction database, a plurality of transaction data entries, wherein each transaction data entry includes data related to a payment transaction involving the consumer including at least a specific brand identifier associated with a brand involved in the related payment transaction;
identifying, by a processing device, an associated brand profile for each transaction data entry in the transaction database where the included brand identifier corresponds to the specific brand identifier included in the respective transaction data entry;
identifying, by the processing device, one or more repulsive brands based on at least (i) a frequency of an associated competitor brand identifier in the plurality of competitor brand identifiers included in each associated brand profile identified for each transaction data entry in the transaction database, and (ii) a brand preference level of the plurality of brand preference levels included in the consumer profile associated with the respective brand;
storing, in the consumer profile, the identified one or more repulsive brands;
receiving, by a receiving device, transaction data for a payment transaction involving the consumer, wherein the transaction data includes at least an involved brand identifier, and
updating, by the processing device, a brand preference level associated with the brand associated with the involved brand identifier in the consumer profile.

12. A system for identifying repulsive brands, comprising:
a brand database configured to store a plurality of brand profiles, wherein each brand profile includes data related to a brand including at least a brand identifier and a plurality of competitor brand identifiers associated with competitors to the related brand;
a transaction database configured to store a plurality of transaction data entries, wherein each transaction data entry includes data related to a payment transaction involving a consumer including at least a specific brand identifier associated with a brand involved in the related payment transaction; and
a processing device configured to
identify an associated brand profile for each transaction data entry in the transaction database where the included brand identifier corresponds to the specific brand identifier included in the respective transaction data entry, and
identify one or more repulsive brands based on inclusion of an associated competitor brand identifier in the plurality of competitor brand identifiers included in each associated brand profile identified for each transaction data entry in the transaction database.

13. The system of claim 12, wherein the one or more repulsive brands are identified based on a frequency of the associated competitor brand identifier in the identified associated brand profiles.

14. The system of claim 12, further comprising:
a profile database configured to store a consumer profile, wherein the consumer profile includes data related to the consumer.

15. The system of claim 14, wherein the processing device is further configured to store, in the consumer profile, the identified one or more repulsive brands.

16. The system of claim 15, wherein
the consumer profile further includes a plurality of brand preference levels, each brand preference level associated with a brand, and
the one or more repulsive brands are identified further based on a brand preference level of the plurality of brand preference levels associated with the respective repulsive brand.

17. The system of claim 16, further comprising:
a receiving device configured to receive transaction data for a payment transaction involving the consumer, wherein the transaction data includes at least an involved brand identifier.

18. The system of claim 17, wherein the processing device is further configured to update, in the consumer profile, a brand preference level associated with a brand associated with the involved brand identifier.

19. The system of claim 17, wherein the processing device is further configured to
identify a specific brand profile where the included brand identifier corresponds to the involved brand identifier, and
update, in the consumer profile, a brand preference level associated with a brand associated with each competitor brand identifier included in the identified specific brand profile.

20. The system of claim 17, wherein
the involved brand identifier corresponds to a repulsed brand of the one or more repulsive brands, and
the processing device is further configured to remove, from the consumer profile, the repulsed brand corresponding to the involved brand identifier.

21. The system of claim 16, wherein the plurality of brand preference levels are based on at least one of: transaction history, survey data, product return data, customer service data, social media data, and related consumer data.

22. A system for identifying repulsive brands, comprising:
a profile database configured to store a consumer profile, wherein the consumer profile includes data related to a consumer including at least a plurality of brand preference levels, each brand preference level being associated with a brand;
a brand database configured to store a plurality of brand profiles, wherein each brand profile includes data related to a brand including at least a brand identifier and a plurality of competitor brand identifiers associated with competitors to the related brand;
a transaction database configured to store a plurality of transaction data entries, wherein each transaction data entry includes data related to a payment transaction involving the consumer including at least a specific brand identifier associated with a brand involved in the related payment transaction; and
a processing device configured to
identify an associated brand profile for each transaction data entry in the transaction database where the included brand identifier corresponds to the specific brand identifier included in the respective transaction data entry,
identify one or more repulsive brands based on at least (i) a frequency of an associated competitor brand identifier in the plurality of competitor brand identifiers included in each associated brand profile identified for each transaction data entry in the transaction database, and (ii) a brand preference level of the plurality of brand preference levels included in the consumer profile associated with the respective brand, and
store, in the consumer profile, the identified one or more repulsive brands; and
a receiving device configured to receive transaction data for a payment transaction involving the consumer, wherein the transaction data includes at least an involved brand identifier, wherein
the processing device is further configured to update a brand preference level associated with the brand associated with the involved brand identifier in the consumer profile.
